(19) United States
(12) Patent Application Publication
(10) Pub. No.: US 2012/0227507 A1
(43) Pub. Date: Sep. 13, 2012

(54) INSTRUMENTED COUPLER LOAD CELL FOR ROCK ANCHORS

(76) Inventor: Hani Sabri MITRI, Saint-Lambert (CA)

(21) Appl. No.: 13/347,567

(22) Filed: Jan. 10, 2012

Related U.S. Application Data
(60) Provisional application No. 61/460,802, filed on Jan. 10, 2011.

(51) Int. Cl. F16B 31/02

(52) U.S. Cl. 73/761

(57) ABSTRACT

A load-measuring coupling device for rock anchors comprises a body having a threaded section for receiving a bearing plate and a nut, and a hollow section having a threaded hole to allow a threaded rock anchor head to be fitted thereinto. The body has a central blind hole extending from the threaded section for receiving a strain gauge lengthwise therein, to sense the axial stretch induced in the gauge due to applied loads on the rock anchor head. The strain gauges are attached to a connector located at the threaded section, which permits the transmission of the strain gauge signal to a reader unit. The coupling device is attached to the rock anchor and the assembly is inserted in a hole in a mine. The rock anchor can be pre-tensioned with a shear pin in the hollow section or a jamming nut in the threaded section.

### CROSS REFERENCE TO RELATED APPLICATIONS

This application claims priority on U.S. Provisional Application No. 61/460,802 filed on Jan. 10, 2011, which is herein incorporated by reference.

### FIELD OF THE INVENTION

The present invention pertains to rock anchors (rock bolts) and, more particularly, to the load monitoring of rock anchors used for ground support in mining and civil engineering applications.

### BACKGROUND OF THE INVENTION

It is well known that the consequences of rock falls in underground mines can be disastrous. Rock falls can cause injuries and fatalities, and can also be responsible for mine production delays. Therefore, much attention is given to the design and installation of adequate rock support systems in underground mines. Rock anchors, such as mechanical rock bolts and resin grouted rebars, are installed in almost all mine access areas such as gate roads, drifts, ramps and shafts. Due to their important role as primary rock support, it is necessary to verify that the rock bolt is functioning adequately and is not subjected to an excessive load. There are many situations in underground mines and tunnels where such a concern may arise especially in development and production areas where the ground response changes constantly due to mining induced stress changes.

The need to measure the rock anchor load with instrumentation methods has been recognized by researchers and new measurement techniques were developed and became commercially available. One of such techniques is the hollow load cell technology. As the load cell is sandwiched between a face plate and a reaction plate, it measures the axial strain inside the cell, from which the axial bolt load is calculated. The disadvantage of this technology is that the face and reaction plates must be placed perpendicular to the rock anchor to capture the correct reaction force, which is not always possible in many mining and civil applications. Also, rock surface preparation is often required to make sure that the rock surface and the reaction plates are perfectly parallel. Another disadvantage is that the hollow load cell reduces the headroom of the mine opening or the tunnel.

To overcome the drawbacks associated with the use of the hollow load cell technology, a design that is based on placing a strain gauge directly in the rock anchor head by drilling a central blind hole that extends beyond the threaded portion was developed, hereinafter referred to as the instrumented rock anchor design. As the strain gauge is placed in the axial direction, it measures the load-induced axial strains, which can be converted to bolt axial loads. Unlike the hollow load cell, the embedded strain gauge in the rock anchor head requires no additional headroom in the drift, and does not require any surface preparation. Thus, this technique is not prone to erroneous measurements due to the position of the face plate with respect to the rock surface. It can be seen that this technique is applicable to virtually any type of rock anchors, such as mechanical rock bolts, cone bolts, grouted rebars, and forged head bolts.

In spite of the above mentioned features, the instrumented rock anchor design has drawbacks that limit its suitability to mining applications. One deficiency of this design is the need to transport the rock anchor back and forth to the mine. This results in additional materials handling work and cost. It also exposes the head connector to damage during shipping and handling. Another deficiency is that the hole drilled in the bolt head reduces its capacity. Even if the diameter of the hole is only 20% of that of the rock anchor diameter, the loss of rock strength is 4%. The strain gauge being installed in the rock anchor itself is thus unable to capture the ultimate breaking strength of the rock anchor. Most rock anchors have an ultimate strength that is 10%-15% greater than the yield load. Thus, it can be said that even if the rock anchor load reaches the yield limit, it can still offer further load supporting capability before it eventually breaks.

While the design concept of the instrumented rock anchor offers advantages over the traditional hollow load cell technology, it is nevertheless not practical for mining applications because of the design deficiencies mentioned above.

There is thus still a need for a new concept for monitoring the axial load on the rock anchor head.

### SUMMARY OF THE INVENTION

It is therefore an aim of the present invention to provide a novel load-measuring coupling device for rock anchors.

Therefore, in accordance with the present invention, there is provided a load-measuring coupling device for use on an anchor engaged in a structural medium, comprising a body including a threaded section and a hollow section, the hollow section being adapted to be connected to the anchor, the threaded section being adapted to be engaged to the structure for securing the body thereto, at least one strain gauge extending in the body for measuring a load applied to the anchor.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present invention, and in which:

FIG. 1 is a schematic cross sectional view of the instrumented coupler load cell or load-measuring coupling device in accordance with a first embodiment of the present invention, showing the device installed in a rock surface and connected to a rock anchor (only a proximal portion thereof being herein shown), the coupling device including a load cell having one strain gauge;

FIG. 2 is a schematic cross sectional view of a load-measuring coupling device in accordance with a second embodiment of the present invention, which is similar to the device of FIG. 1 but wherein the load cell has two strain gauges;

FIG. 3 is a schematic cross sectional view of a load-measuring coupling device in accordance with a third embodiment of the present invention, which is similar to the device of FIG. 1 but wherein the device includes a shear pin and bonding material is provided in the drill hole;

FIG. 4 is a schematic cross sectional view of a load-measuring coupling device in accordance with a fourth embodiment of the present invention, which is similar to the device of FIG. 1 but wherein the device includes a jamming nut and bonding material is provided in the drill hole;

FIGS. 5 and 6 are schematic perspective and side elevation views, respectively, of a body of the load-measuring coupling device;

FIG. 7 is a cross sectional view taken along line 7-7 of FIG. 6;

FIG. 8 is an end elevation view taken at line 8-8 of FIG. 7;

FIG. 9 is a schematic perspective view of a nut of the load-measuring coupling device;

FIG. 10 is an end elevation view of the nut;

FIG. 11 is a cross sectional view taken along line 11-11 of FIG. 10;

FIG. 12 is a schematic perspective view of a protective cap of the load-measuring coupling device;

FIG. 13 is an end elevation view of the protective cap;

FIG. 14 is a cross sectional view taken along line 14-14 of FIG. 13;

FIG. 15 is an end elevation view of a first variant of the protective cap;

FIG. 16 is a cross sectional view taken along line 16-16 of FIG. 15;

FIG. 17 is an end elevation view of a second variant of the protective cap; and

FIG. 18 is a cross sectional view taken along line 18-18 of FIG. 17.

### DESCRIPTION OF ILLUSTRATIVE EMBODIMENTS OF THE INVENTION

In general, the present load-measuring coupling device is a rock anchor coupler load cell that is instrumented with one or two or more strain gauges that are embedded in blind boreholes along the axis of the coupler. The coupler load cell is fitted onto the rock anchor, such that, once installed in the rock, the coupler load cell can sense and monitor the rock anchor head axial load. The advantages of this design are numerous. The coupler load cell is designed so that its elastic limit resistance is greater than the ultimate breaking strength of the rock anchor. This design ensures a complete load path monitoring of rock anchor performance until its failure. The coupler load cell design offers the advantages of light weight in shipping and handling as well as ease of installation in the field. Furthermore, it can be fitted to a rock anchor of any length, and any size.

The coupler load cell basically comprises a solid round bar or body typically made from steel, which at one (visible) end, called the threaded section, is threaded on the outside to receive a bearing plate with a central hole and a nut, and which at an other (hidden) end, called the hollow section, has a threaded hole to allow a threaded rock anchor head to be threadably fitted thereinto. Each strain gauge is embedded in a blind hole in the body and is oriented in the hole length direction, to sense the axial stretch induced in the gauge due to applied loads on the rock anchor head. The embedded strain gauges are attached to a connector located at the threaded end. The connector permits the transmission of the strain gauge signal to a strain gauge reader unit through an instrumentation wire.

More particularly, and with reference to the drawings, there will now be described a load-measuring coupling device D, also called the instrumented coupler load cell, as being used in mining applications to monitor the axial load in a rock anchor supporting a roof of a mine or tunnel. However, it should be understood that other applications of the load-measuring coupling device D are contemplated. For example, the load-measuring coupling device D could be used to monitor the axial load in a soil anchor supporting a retaining wall or a slope.

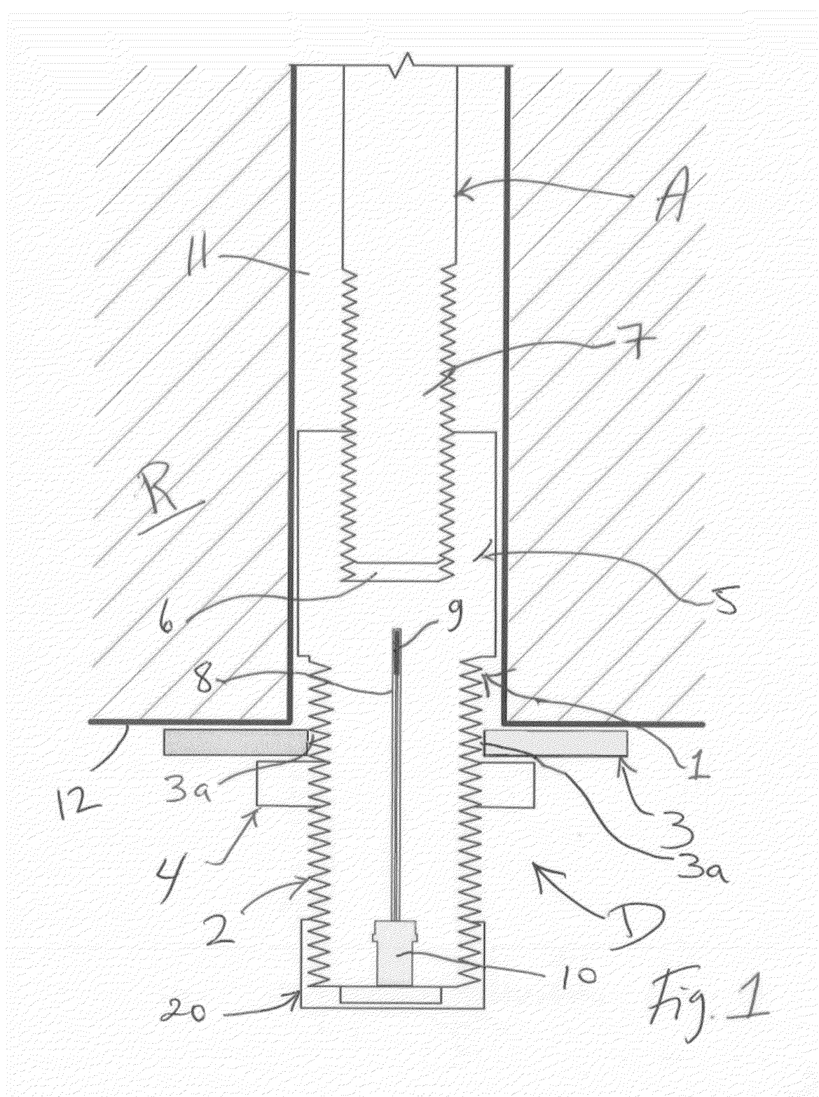

Turning to FIG. 1, a first embodiment of the load-measuring coupling device D will be described. The load-measuring coupling device D comprises a solid round bar or body 1 for instance made from steel, a nut 4 and a protective cap 20. The body 1 includes a threaded section 2 and a hollow section 5. The threaded section 2 is threaded on the outside to receive a bearing plate 3 defining a central hole 3a and the nut 4. The hollow section 5 has a threaded hole 6 to allow a threaded head 7 of a rock anchor A to be fitted into the hollow section 5.

A blind hole 8 is defined in the body 1, the blind hole 8 being driven from the threaded section 2. A strain gauge 9 is embedded in the blind hole 8 and is oriented in the hole length direction, to sense the axial stretch induced in the gauge 9 due to a load applied on the rock anchor head 7. The embedded strain gauge 9 is attached to a connector 10 located at a proximal end of the threaded section 2.

The load-measuring coupling device D is fitted onto the rock anchor head 7 before it is installed. A typical installation using a mechanical rock anchor with expansion shell requires that a drill hole 11 be first driven in the rock R to a length of that corresponds to the combined length of the rock anchor A and the load-measuring coupling device D. The load-measuring coupling device and rock anchor assembly D and A is inserted into the drill hole 11 and rotated by means of a conventional drill like a stoper or a jackleg or specialized rock bolting equipment. Rotation is maintained until the expansion shell has gripped to the surface of the drill hole 11 and the bearing plate 3 is firmly pushed against the rock surface 12. A torque is further applied by the drill to the nut 4 to achieve the desired pretension.

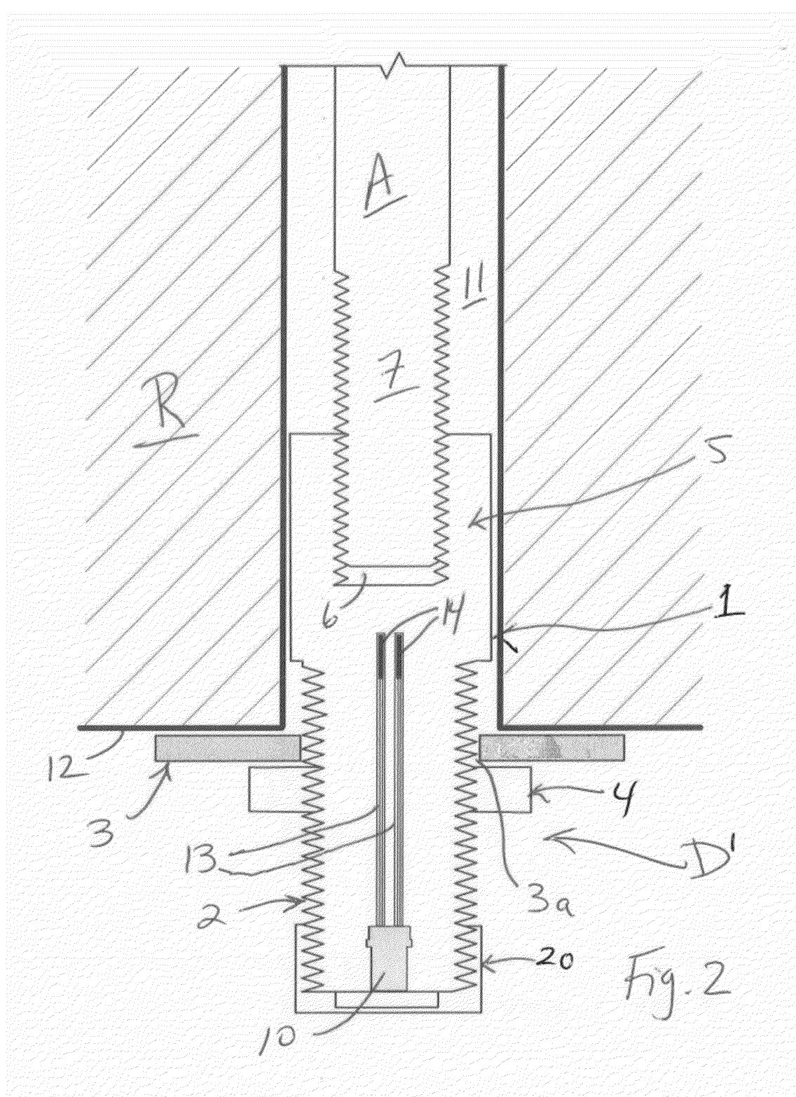

Turning to FIG. 2, a second embodiment of the load-measuring coupling device D′ will be described. The load-measuring coupling device D′ is similar to the load-measuring coupling device D of FIG. 1, except that it is provided with two or three symmetrically positioned blind holes 13 for receiving a corresponding number of strain gauges 14, which are embedded in the blind holes 13. In this embodiment, the accuracy of axial strain measurement, and hence the estimation of the rock anchor axial load, is improved by taking the average of the readings taken from the two or three strain gauges 14.

Turning to FIG. 3, a third embodiment of the load-measuring coupling device D″ will be described. The load-measuring coupling device D″ is fitted onto the rock anchor head 7 then inserted in the drill hole (11) driven in the rock R. The load-measuring coupling device D″ is similar to the load-measuring coupling device D of FIG. 1, except that it is adapted for use in applications requiring the use of bonding material 17, such as resin, between the rock anchor A and the rock R inside the drill hole 11. In such cases, it is necessary to provide the means for the rock anchor A to spin in the drill hole 11 to enable the mixing of the resin components in the borehole. For this purpose, a shear pin 15 is inserted across the hollow section 5 at the end of the threaded hole 6. The hollow section 5 is further extended beyond the shear pin 15 and a borehole 16 is provided to make room for the shear pin 15 after it has been sheared off.

This installation requires that the drill hole 11 is first defined in the rock R to a length of that corresponds to the combined length of the rock anchor A and the load-measuring coupling device D″. Bonding material 17 such as resin cartridges are then inserted into the drill hole 11, with the fast setting resin being inserted first, followed by the slow setting resin. The load-measuring coupling device D″ and the rock anchor head 7, once attached, are pushed into the hole 11 by means of a conventional drill like a stoper or a jackleg or specialized rock bolting equipment. The pushing action causes the resin cartridges to rupture. The drill is then used to rotate the nut 4 of the load-measuring coupling device D″. This causes the nut 4 to advance until the bearing plate 3 comes in contact with the rock surface 12 and the rock anchor head 7 to advance down the threaded hole 6 until it hits the shear pin 15. The rock anchor head 7 will then spin in the drill hole 11 thus mixing the resin components 17. After some time has been allowed for the fast resin to set at the toe of the drill hole 11, the drill is used to apply further torque to the nut 4 until the shear pin 15 breaks off and falls in the borehole 16, and the rock anchor head 7 advances further in the bore hole 16 thus causing anchor tensioning and the bearing plate 3 to push firmly against the rock surface 12.

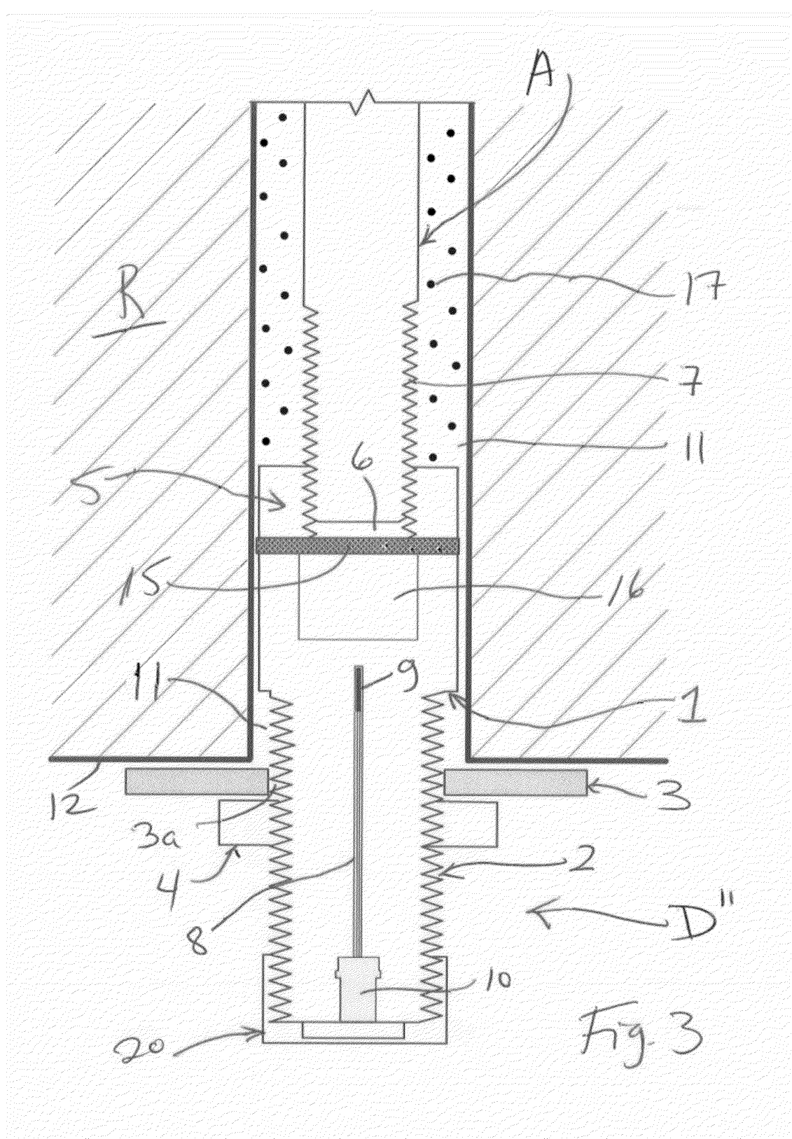

Turning to FIG. 4, a fourth embodiment of the load-measuring coupling device D′″ will be described. It presents an alternative method for the installation of the rock anchor A with bonding material 17. In this embodiment, a jamming nut 18 is used to enable the application of the torque needed to spin the load-measuring coupling device and rock anchor assembly D′″ and A to mix the resin components 17 as described above.

In all of the above described embodiments, the connector 10 has the function of transmitting the strain gauge signal to a strain gauge readout unit through an instrumentation wire. The strain gauge or gauges 9, 14 are connected with dummy precision resistors inside the threaded section 2 to complete a Wheatstone Bridge circuit. Alternatively, the Wheatstone Bridge circuit can be completed outside the threaded section 2 using the strain gauge readout unit, in which case only the strain gauge or gauges 9, 14 inside the drill hole(s) 11 are attached to the connector 10. The protective cap 20, which is removably threadably engaged to the proximal (visible) end of the threaded section 2 is provided for protecting the connector 10,

The embedded strain gauge 9 or strain gauges 14 can be fastened in place by using a bonding material such as glue or epoxy to ensure that the strain gauge is well adhered and will sense the stretch in the load-measuring coupling devices D, D′, D″ and D′″ once load is applied to the rock anchor head 7.

The threaded section 2 of the load-measuring coupling devices can be made to any desired size and type. The hollow section 5 is threaded on the inside to fit any size and type of rock anchor A. The threaded hole 6 is deep enough to transmit the maximum rock anchor force possible, which corresponds to the rock anchor ultimate breaking strength. The diameter of the round bar or body 1 is designed such that its elastic limit resistance is greater than the ultimate breaking strength of the rock anchor A.

In the event that the drill hole 11 is smaller in diameter than the diameter of the round bar 1, the drill hole 11 may be collared by enlarging the end toward the rock surface 12 enough to fit the instrumented coupler load cell.

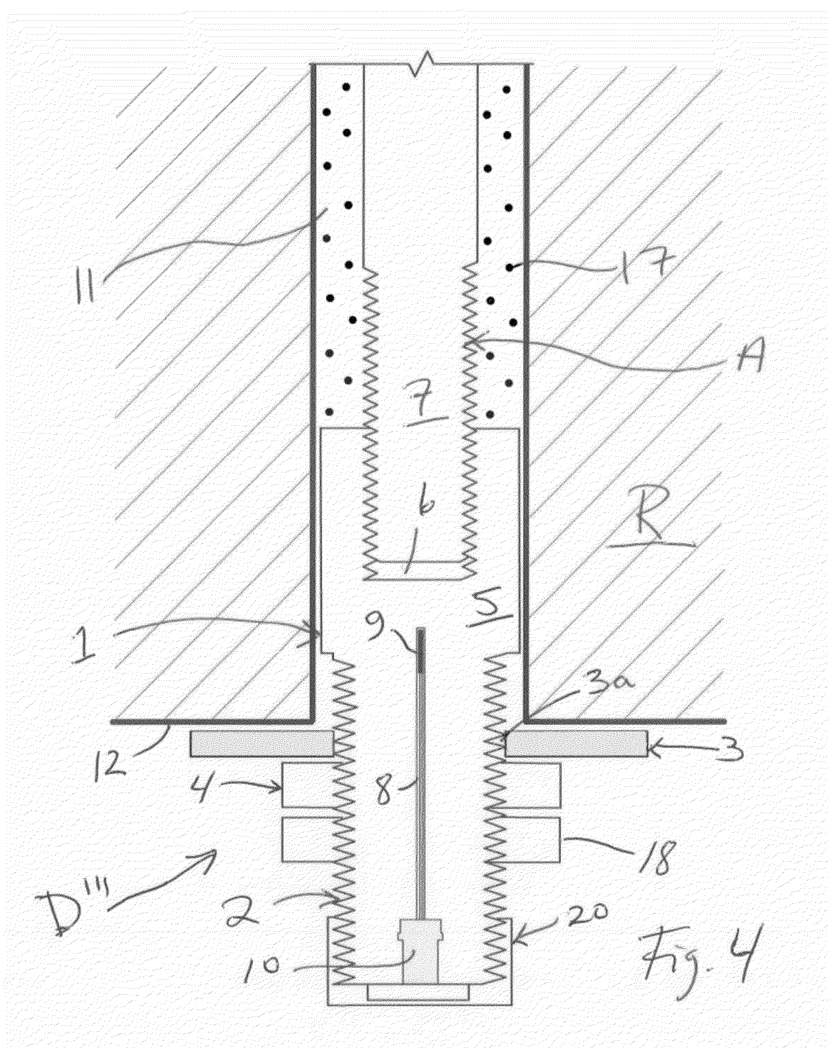

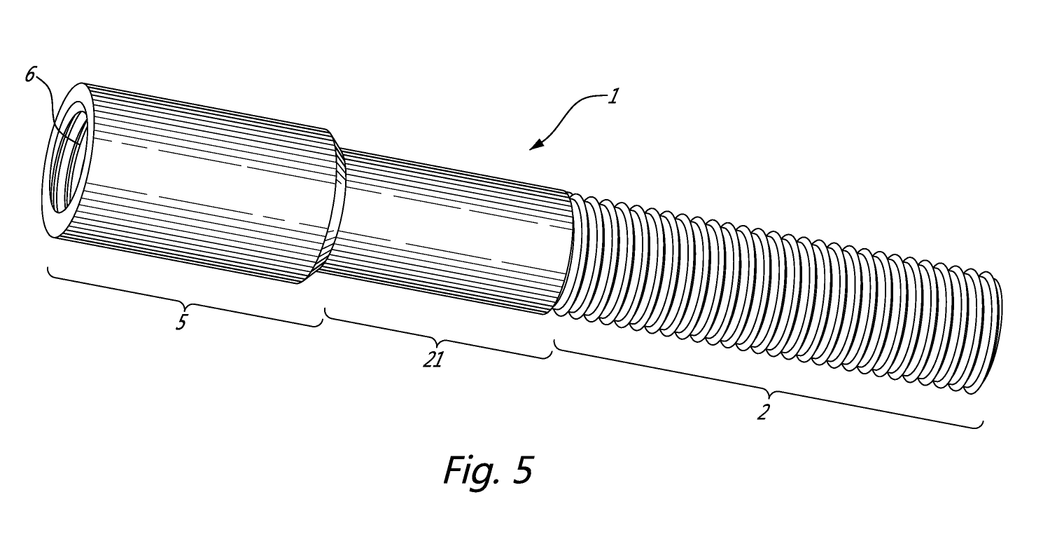

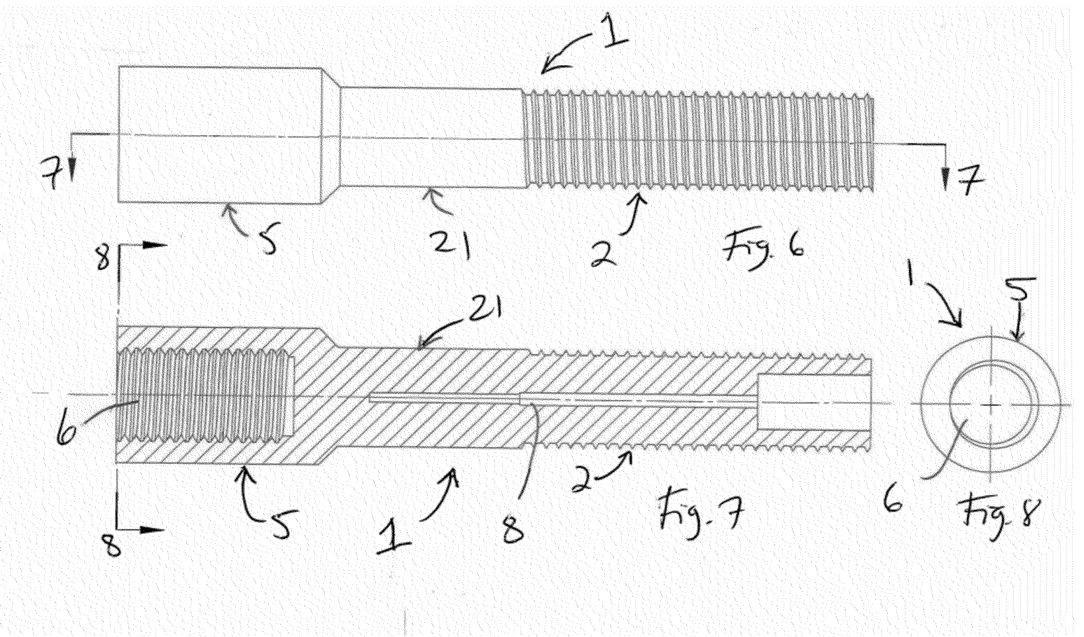

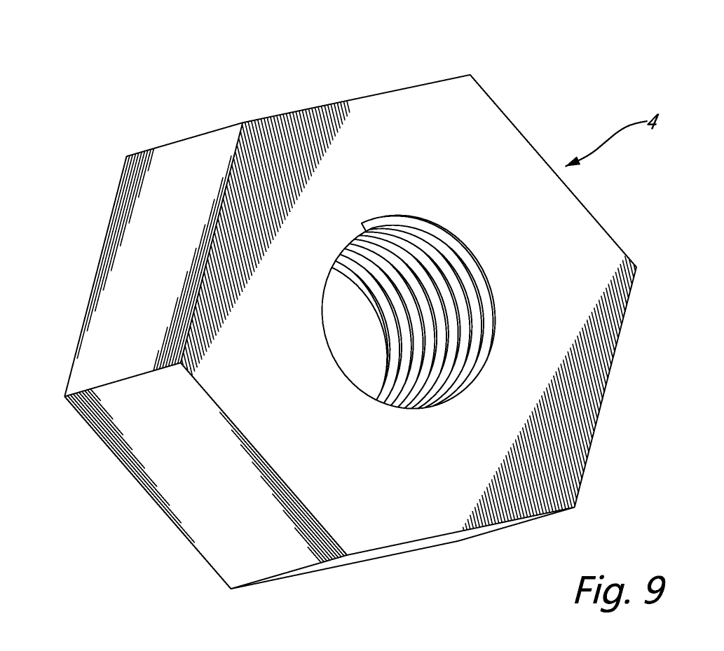

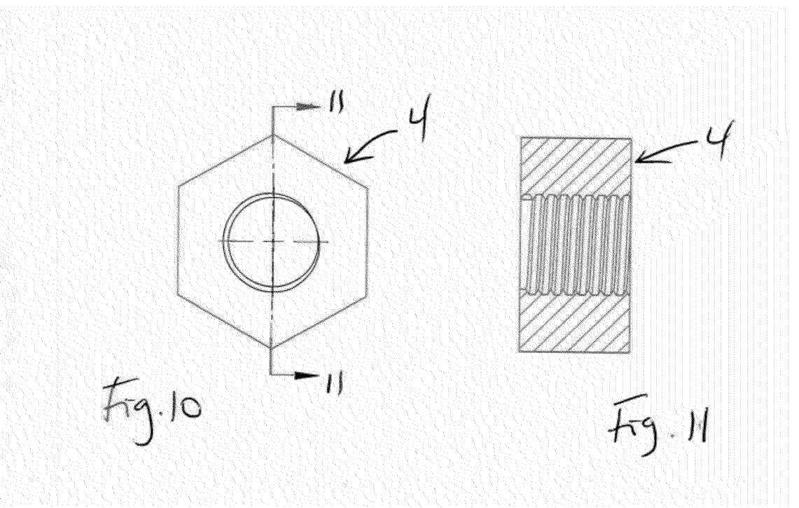

FIGS. 5 to 8 illustrate isolated views of the body 1, noting that the body 1 is slightly different than that shown in FIGS. 1 to 4, in that an intermediate section 21 (extending between the threaded and hollow sections 2 and 5) of the body is smooth as opposed to being outwardly threaded as in FIGS. 1 to 4.

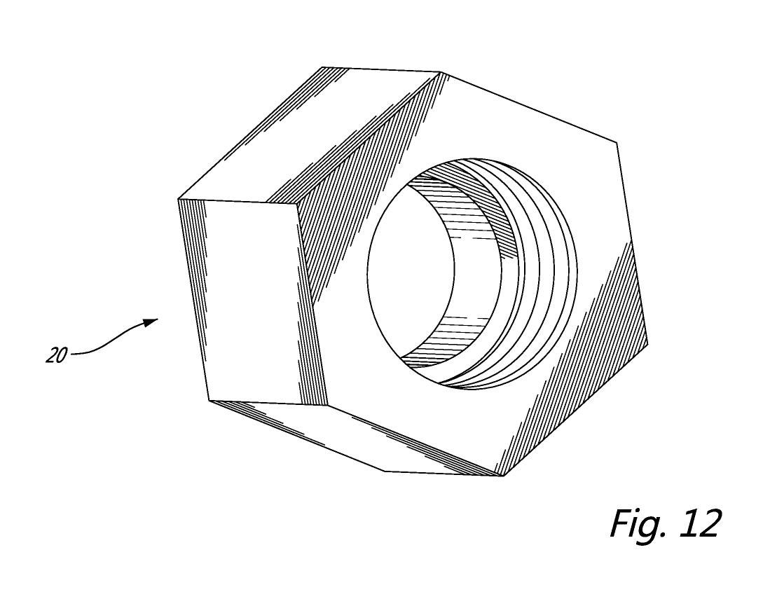

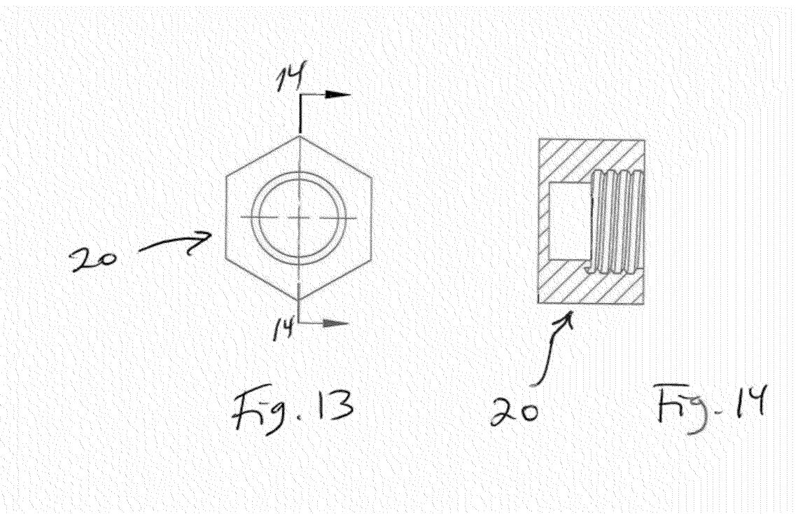

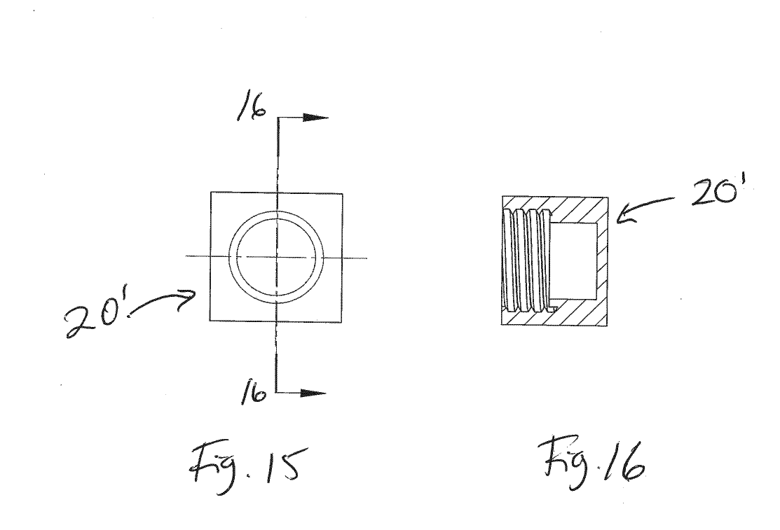

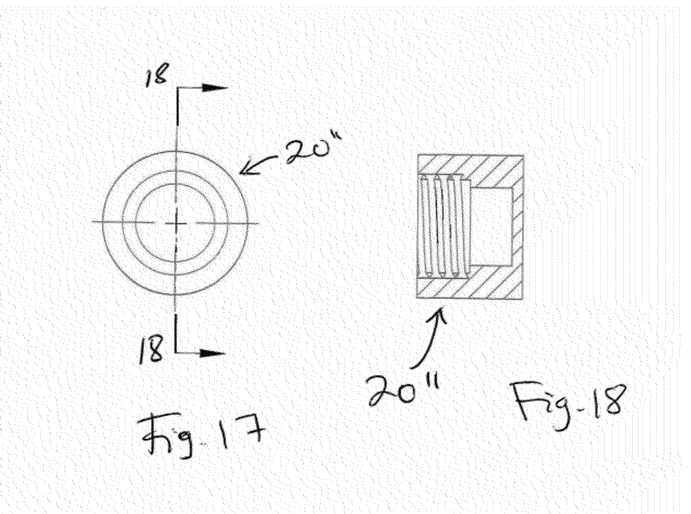

FIGS. 15-16 and 17-18 show a pair of variants 20′ and 20″, respectively, of the protective cap 20 shown in FIGS. 1 to 4 and 12 to 14. The protective cap 20 is hexagonally shaped, whereas the protective caps 20′ and 20″ are respectively square and round shaped.

Although the present invention has been described hereinabove by way of embodiments thereof, it may be modified, without departing from the nature and teachings of the subject invention as described herein.

1. A load-measuring coupling device for use on an anchor engaged in a structural medium, comprising a body including a threaded section and a hollow section, the hollow section being adapted to be connected to the anchor, the threaded section being adapted to be engaged to the structure for securing the body thereto, at least one strain gauge extending in the body for measuring a load applied to the anchor.

2. A load-measuring coupling device as defined in claim 1, wherein the device allows the measurement of the load applied to the anchor until the ultimate breaking strength of the anchor is reached.

3. A load-measuring coupling device as defined in claim 1, wherein the device has an elastic limit resistance to axial loads, which is greater than the ultimate breaking strength of the anchor that is coupled thereto.

4. A load-measuring coupling device as defined in claim 1, wherein the device allows the pre-tensioning of the anchor to any desired force, in the same manner as in the installation of rock anchor without the load-measuring coupling device.

5. A load-measuring coupling device as defined in claim 1, wherein the device is adapted to allow spinning of the anchor inside the structure for applications requiring a spinning action of the anchor to mix resin cartridge components, a shear pin in the hollow section or a jamming nut in the threaded section being provided therefor.

6. A load-measuring coupling device as defined in claim 1, wherein the anchor is provided with male threads with the hollow section defining a hole having corresponding female threads for engagement with the female threads of the anchor.

7. A load-measuring coupling device as defined in claim 6, wherein the anchor is a rock anchor having an anchor head, the hollow section being adapted to be threadably engaged to the anchor head.

8. A load-measuring coupling device as defined in claim 1, wherein the strain gauge extends in a blind hole defined in the body and opening up at a proximal end of the threaded section.

9. A load-measuring coupling device as defined in claim 1, wherein a connector is provided at a proximal end of the threaded section, the connector being connected to the strain gauge.

10. A load-measuring coupling device as defined in claim 9, wherein a protective cap is provided at the proximal end of the threaded section for protecting the connector.

11. A load-measuring coupling device as defined in claim 10, wherein the protective cap is removably mounted to the proximal end of the threaded section.

12. A load-measuring coupling device as defined in claim 1, wherein a nut is provided for engaging the threaded section exteriorly of the structure and securing the body to the structure.

13. A load-measuring coupling device as defined in claim 12, wherein a bearing plate is provided for positioning around the threaded section and between the nut and the structure.
